(19) United States
(12) Patent Application Publication
(10) Pub. No.: US 2018/0217450 A1
(43) Pub. Date: Aug. 2, 2018

(54) LIQUID CRYSTAL DISPLAY DEVICE AND METHOD FOR MANUFACTURING THE SAME

(71) Applicant: Shenzhen China Star Optoelectronics Technology CO., Ltd., Shenzhen, Guangdong (CN)

(72) Inventors: Chao Ma, Shenzhen, Guangdong (CN); Hsiao Hsien Chen, Shenzhen, Guangdong (CN)

(73) Assignee: Shenzhen China Star Optoelectronics Technology Co. , Ltd., Shenzhen, Guangdong (CN)

(21) Appl. No.: 15/500,294

(22) PCT Filed: Jan. 20, 2017
(86) PCT No.: PCT/CN2017/071958

§ 371 Date: Jan. 31, 2017

(30) Foreign Application Priority Data
Jan. 13, 2017 (CN) 201710025425.1

(51) Int. Cl. G02F 1/1337; G02F 1/1343; G02F 1/1335

(52) U.S. Cl. CPC G02F 1/133788; G02F 1/134336; G02F 1/133516; G02F 1/133753; G02F 2001/133614; G02F 2001/134345; G02F 2202/06; G02F 2001/133757; G02F 1/133621

(57) ABSTRACT

Disclosed is a liquid crystal display device. The liquid crystal display device includes a plurality of pixel structures. Each pixel structure includes a red sub-pixel, a green sub-pixel, and a blue sub-pixel. An area of the blue sub-pixel is greater than or equal to a sum of an area of the red sub-pixel and an area of the green sub-pixel. The disclosed liquid crystal display device has features of high exposure precision, high contrast, fast response, and high resolution.

### CROSS-REFERENCE TO RELATED APPLICATIONS

The present application claims the priority of Chinese patent application CN 201710025425.1, entitled “Liquid crystal display device and method for manufacturing the same” and filed on Jan. 13, 2017, the entirety of which is incorporated herein by reference.

### FIELD OF THE INVENTION

The present disclosure relates to the technical field of liquid crystal display, and in particular, to a liquid crystal display device and a method for manufacturing the same.

### BACKGROUND OF THE INVENTION

A liquid crystal display (LCD) device comprises a color filter (CF) substrate and an array substrate which are arranged opposite each other. Transparent electrodes are provided on inner sides of the two substrates and a liquid crystal molecule layer is provided between the two substrates. The LCD device, changes polarization state of light through control exerted on liquid crystal molecule orientations by an electric field and realizes passage and blocking of light by means of a polarizer, so as to achieve the object of display.

Thin-film transistor liquid crystal display (TFT-LCD) screens have gradually dominated the display field, thanks to their outstanding features including low power consumption, excellent image quality, high yield, etc. The existing liquid crystal panels, according to different display modes, mainly adopts vertical alignment (VA) technology, in-plane switching (IPS) technology, and fringe field switching (FFS) technology which is usually adopted in small-sized panels. These display technologies each also have different alignment methods. At present, rubbing alignment is a widely used alignment technology in TFT-LCD production. Rubbing alignment can provide liquid crystal molecules with strong alignment capacities. Yet, during the rubbing, due to flannelette contact, contamination of static electricity and particles will be caused, which usually leads to damage of liquid crystal elements. Thus, to avoid contamination of static electricity and particles and to find an alignment method which can easily control liquid crystal molecules, researchers are unceasingly working on and trying to improve non-contact alignment methods. By means of a non-contact alignment method, masks for certain patterns can be used to achieve small-area alignment and further to manufacture certain specially-demanded liquid crystal elements. A well-known non-contact alignment method is called ultraviolet light photo-alignment method, for short, photo-alignment, which irradiates an alignment agent which has a sensitizer with linear polarized ultraviolet light.

Photo-alignment is a process of irradiating a macromolecular polymer alignment agent which has a sensitizer with linear polarized ultraviolet light, which can avoid surface contamination of a glass substrate, perform small-area alignment, align a pattern through a mask, and control parameters of a liquid crystal unit through adjusting an angle of and irradiation time length of an incident ray, such as a pretilt angle, surface orientation intensity, etc. Alignment agents used for photo-alignment generally can be classified into three types. As for the first type, after an alignment film is irradiated with linear polarized ultraviolet light, molecules in a polarity direction bond together and form long-bond molecules, which makes the alignment film distributed in an anisotropic way and makes liquid crystal molecules arranged along the long-bond molecules. As for the second type, after an alignment film is irradiated with linear polarized ultraviolet light, long-bond molecules in a polarity direction are broken by ultraviolet light, which makes the alignment film distributed in an anisotropic way and makes liquid crystal molecules arranged along long-bond molecules which are not broken. The third type, cis-trans, generally uses an alignment agent which has an azo molecule; the alignment agent is arranged in different directions before and after being irradiated. Alignment of the foregoing three types can all exert satisfied alignment effects and have advantages of high aperture ratio, high contrast, fast response, etc.

A quantum dot, as a new display device material, has been commonly recognized and attracted wide attention. The quantum dot is a quasi-zero-dimensional nanometer material comprising a small number of atoms. Roughly speaking, a quantum dot has three dimensions which are all below 100 nm in size and looks like a tiny dot; electrons inside the quantum dot are confined in movement in all directions, making the “quantum confinement effect” particularly notable. The quantum dot has a wide and continuously-distributed excitation spectrum, a narrow and symmetrical emission spectrum, an adjustable color, a highly-stable photochemistry, and a long fluorescence lifetime, making it an ideal light-emitting material. At present, quantum dots can be classified into two types according to different ways of obtaining energy, one being photoluminescent quantum dots and the other being electroluminescent quantum dots. Emission color of a quantum dot is controlled by changing the size effect thereof, i.e. by controlling the shape, structure, and size of the quantum dot by means of which energy gap of the quantum dot, confinement energy of the exciton, and energy blue-shift of the exciton are adjusted.

### SUMMARY OF THE INVENTION

In one aspect, the present disclosure provides a liquid crystal display device which comprises a plurality of pixel structures. Each pixel structure comprises a red sub-pixel, a green sub-pixel, and a blue sub-pixel. An area of the blue sub-pixel is greater than or equal to a sum of an area of the red sub-pixel and an area of the green sub-pixel.

According to one preferred embodiment of the present disclosure, the pixel structures are in squares.

According to one preferred embodiment of the present disclosure, the area of the blue sub-pixel accounts for a half of an area of a pixel structure and the area of the red sub-pixel is equal to the area of the green sub-pixel. Preferably, the red sub-pixel and the green sub-pixel are both in squares; the area of the red sub-pixel and the area of the green sub-pixel respectively accounts for a quarter of the area of the pixel structure.

According to one preferred embodiment of the present disclosure, the pixel structures are arranged in array.

According to one preferred embodiment of the present disclosure, a backlight of the liquid crystal display device is blue light; the blue sub-pixel relies on the backlight to emit blue light; the red sub-pixel and the green sub-pixel are respectively doped with a red quantum dot material and a green quantum dot material. Or a backlight of the liquid crystal display device is white light; the blue sub-pixel, the red sub-pixel, and the green sub-pixel are respectively doped with a blue quantum dot material, a red quantum dot material, and a green quantum dot material.

According to one preferred embodiment of the present disclosure; the blue quantum dot material, the red quantum dot material, and the green quantum dot material are present in an amount of 4 wt % to 20 wt % respectively.

In another aspect, the present disclosure provides a method for manufacturing a liquid crystal display device. The method comprises steps of: Step S1, respectively manufacturing a color filter substrate and an array substrate and respectively performing surface treatment on the two substrates; Step S2, respectively coating the color filter substrate and the array substrate with an alignment agent, and irradiating the alignment agent to form an alignment film (photo-alignment); and Step S3, assembling the color filter substrate and the array substrate.

The liquid crystal display device comprises a plurality of pixel structures. Each pixel structure comprises a red sub-pixel, a green sub-pixel, and a blue sub-pixel. An area of the blue sub-pixel is greater than or equal to a sum of an area of the red sub-pixel and an area of the green sub-pixel.

According to one preferred embodiment of the present disclosure, the pixel structures are in squares. Each pixel structure is divided into four sub-regions of a same area.

According to one preferred embodiment of the present disclosure, the area of the blue sub-pixel accounts for a half of an area of a pixel structure and the area of the red sub-pixel is equal to the area of the green sub-pixel. Preferably, the red sub-pixel and the green sub-pixel are both in squares; the area of the red sub-pixel and the area of the green sub-pixel respectively accounts for a quarter of the area of the pixel structure.

According to one preferred embodiment of the present disclosure, the pixel structures are arranged in array.

According to one preferred embodiment of the present disclosure, a backlight of the liquid crystal display device is blue light; the blue sub-pixel relies on the backlight to emit blue light; and the red sub-pixel and the green sub-pixel are respectively doped with a red quantum dot material and a green quantum dot material. Or a backlight of the liquid crystal display device is white light; the blue sub-pixel, the red sub-pixel, and the green sub-pixel are respectively doped with a blue quantum dot material, a red quantum dot material, and a green quantum dot material.

According to one preferred embodiment of the present disclosure, the blue quantum dot material, the red quantum dot material, and the green quantum dot material are present in an amount of 4 wt % to 20 wt % respectively.

According to one preferred embodiment of the present disclosure; a photo-alignment method of the color filter substrate or the array substrate comprises the following steps. A glass substrate is provided on a bearing platform. The alignment agent on the glass substrate is irradiated with linear polarized ultraviolet light by means of a mask. The linear polarized ultraviolet light passes through a light-transmitting region of the mask and irradiates a corresponding region of a pixel structure, so that the alignment agent on the pixel structure which is irradiated forms a first alignment direction. With the mask and irradiating direction of the linear polarized ultraviolet light kept unchanged, the bearing platform is rotated, and other regions of the pixel structure are respectively photo-aligned, so as to obtain an alignment film with different alignment directions.

According to one preferred embodiment of the present disclosure, photo-alignment method of the color filter substrate or the array substrate comprises the following steps. A glass substrate is provided on a bearing platform. The alignment agent on the glass substrate is irradiated with linear polarized ultraviolet light at a specified angle by means of a mask. The linear polarized ultraviolet light passes through a light-transmitting region of the mask and irradiates a corresponding sub-region of a pixel structure, so that the alignment agent on the sub-region forms a first alignment direction. With the mask and irradiating direction of the linear polarized ultraviolet light kept unchanged, the bearing platform is successively rotated by a specified angle for three times, each time rotated by 90°; other three sub-regions of the pixel structure are respectively photo-aligned, successively forming a second alignment direction, a third alignment direction, and a fourth alignment direction. By way of this, an alignment film with four alignment directions is obtained, providing each pixel structure with sub-regions of four alignment directions.

According to one preferred embodiment of the present disclosure, during the photo-alignment process, the glass substrate on a side of the array substrate is rotated by 90° relative to an initial position of the glass substrate on a side of the color filter substrate.

According to one preferred embodiment of the present disclosure, the mask used during the photo-alignment process has a same shape as the pixel structure, and the mask comprises a light-transmitting region and a light-shielding region. The light-transmitting region has a same shape as the red sub-pixel or the green sub-pixel.

According to one preferred embodiment of the present disclosure, an irradiation angle Θ of the linear polarized ultraviolet light is 88°-89.7° during the photo-alignment process.

Pixel structures provided in the present disclosure enlarges an area of blue pixels, which increases blue light efficiencies. Combination of a provided pixel structure and a blue-light exciting quantum dot provides a liquid crystal display device with features of high exposure precision, a wider viewing angle, high saturation, no color cast, high contrast; fast response, and high resolution, no additional cost needed.

### BRIEF DESCRIPTION OF THE DRAWINGS

The accompanying drawings provide further understandings of the present disclosure and constitute one part of the description. The drawings are used for interpreting the present disclosure together with the embodiments, not for limiting the present disclosure. In the drawings:

FIG. 1 schematically shows a pixel structure;

FIG. 2 schematically shows a mask;

FIG. 3 schematically shows perpendicular alignment directions of a color filter substrate and an array substrate after alignment; and

FIG. 4 schematically shows liquid crystal orientations after one-side alignment.

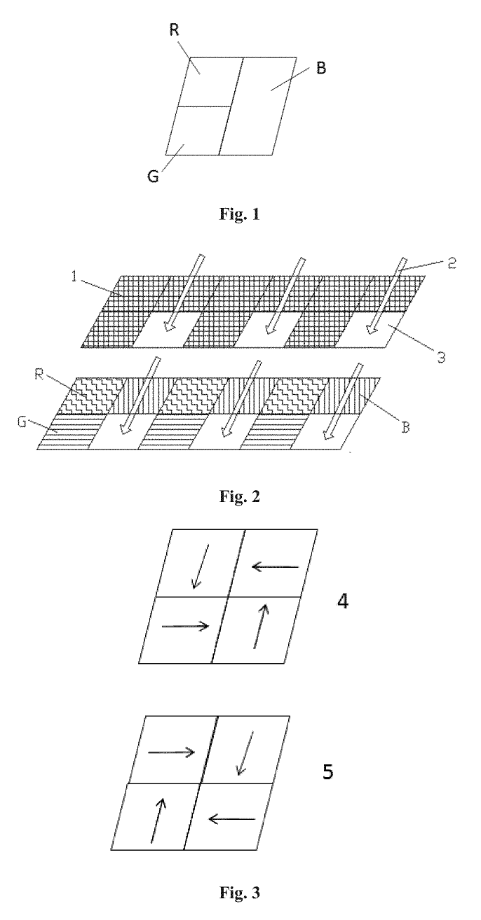

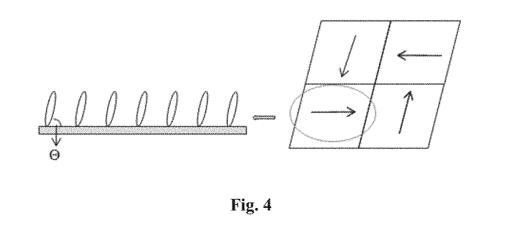

### DETAILED DESCRIPTION OF THE EMBODIMENTS

The present disclosure will be explained in details with reference to the embodiments. Yet, the specific embodiments disclosed herein cannot be understood as limiting the present disclosure in any manner.

### Embodiment 1

In this embodiment, a liquid crystal display device is provided. The liquid crystal display device comprises a plurality of pixel structures. Each pixel structure comprises a red sub-pixel, a green sub-pixel, and a blue sub-pixel. Each pixel structure is divided into four square sub-regions of a same size. The blue sub-pixel occupies two adjacent sub-regions. An area of the blue sub-pixel is twice that of the red sub-pixel or that of the green sub-pixel. The blue sub-pixel relies on the backlight to emit blue light. The pixel structures are arranged in array.

The liquid crystal display device is manufactured according to the following steps. According to conventional TFT-LCD manufacturing procedures, a color filter substrate and an array substrate are respectively manufactured and surface treatment is respectively performed on the two substrates. Before the color filter substrate is coated with an alignment film, R, G, B (red, green, and blue) color filters are respectively prepared using materials doped with quantum dots. Specifically, the color filters are manufactured by successively coating a surface of a glass substrate on a side of the color filter substrate with a transparent photoresist material doped with a red quantum dot material and a transparent photoresist material doped with a green quantum dot material. Both the red quantum dot material and the green quantum dot material are blue-light excitable. The red quantum dot material and the green quantum dot material may be present in the respective transparent photoresist materials in an amount of 4 wt % to 20 wt %. By means of color filter manufacturing technology in similar TFT-LCD manufacturing processes, the color filters are dried, exposed, and developed; patterns matched with a mask are thus formed by etching.

During a cell process, after a photo-alignment polymer is coated, the glass substrate on the side of the color filter substrate and a glass substrate on a side of the array substrate are aligned. A mask having a same shape as the pixel structure is used. The mask comprises a light-transmitting region and a light-shielding region. The light-transmitting region has a same shape as one sub-region.

A photo-alignment method of the color filter substrate comprises the following steps. A glass substrate is provided on a bearing platform. Linear polarized ultraviolet light is provided to irradiate the glass substrate at a specified irradiation angle Θ (88°-89.7° through a light-transmitting region of a mask (here the glass substrate is considered to be arranged horizontally). With the mask kept unchanged, the bearing platform of the glass substrate is rotated by 90° (clockwise or anticlockwise). Linear polarized ultraviolet light is then again provided to irradiate the glass substrate at the specified irradiation angle Θ (88°-89.7°) through a light-transmitting region of a mask. With the mask and irradiating direction of the linear polarized ultraviolet light kept unchanged, the bearing platform of the glass substrate is rotated by 90° (in a same direction as the foregoing procedure). The process is repeated again until four sub-regions of a pixel structure are exposed and photo-aligned.

A photo-alignment method of the array substrate comprises the following steps. A glass substrate is provided on a bearing platform. Linear polarized ultraviolet light is provided to irradiate the glass substrate at a specified irradiation angle Θ (88°-89.7°) through a light-transmitting region of a mask (here the glass substrate is considered to be arranged vertically). With the mask kept unchanged, the glass substrate is rotated by 90° (clockwise or anticlockwise). Linear polarized ultraviolet light is then again provided to irradiate the glass substrate at the specified irradiation angle Θ (88°-89.7°) through a light-transmitting region. With the mask and irradiating direction of the linear polarized ultraviolet light kept unchanged, the bearing platform of the glass substrate is rotated by 90° (in a same direction as the foregoing procedure). The process is repeated again until four sub-regions of a pixel structure are exposed and photo-aligned.

The color filter substrate and the array substrate are assembled with alignment directions thereof perpendicular to each other, and a blue backlight is provided.

The present disclosure is illustrated in detail in combination with certain embodiments hereinabove, but it can be understood that the embodiments disclosed herein can be improved without departing from the protection scope of the present disclosure. The technical features disclosed in each and every embodiment of the present disclosure can be combined with one another in any way, and for consideration of being economic, possible combinations will not be listed in the present disclosure. Therefore, the present disclosure is not limited by the specific embodiments disclosed herein, but includes all technical solutions falling into the protection scope of the claims.

### DESCRIPTION OF THE REFERENCE SIGNS

1 a light-shielding region of a mask
2 linear polarized ultraviolet light
3 a light-transmitting region of a mask
4 color filter substrate
5 array substrate

1. A liquid crystal display device comprising a plurality of pixel structures, wherein each pixel structure comprises a red sub-pixel, a green sub-pixel, and a blue sub-pixel, wherein an area of the blue sub-pixel is greater than or equal to a sum of an area of the red sub-pixel and an area of the green sub-pixel.

2. The liquid crystal display device according to claim 1, wherein the pixel structures are in squares.

3. The liquid crystal display device according to claim 1, wherein the area of the blue sub-pixel accounts for a half of an area of a pixel structure and the area of the red sub-pixel is equal to the area of the green sub-pixel.

4. The liquid crystal display device according to claim 1, wherein the pixel structures are arranged in array.

5. The liquid crystal display device according to claim 1, wherein:
a backlight of the liquid crystal display device is blue light;
the blue sub-pixel relies on the backlight to emit blue light; and
the red sub-pixel and the green sub-pixel are respectively doped with a red quantum dot material and a green quantum dot material which are blue-light excitable.

6. The liquid crystal display device according to claim 1, wherein:
a backlight of the liquid crystal display device is white light; and
the blue sub-pixel, the red sub-pixel, and the green sub-pixel are respectively doped with a blue quantum dot material, a red quantum dot material, and a green quantum dot material.

7. The liquid crystal display device according to claim 5, wherein the red quantum dot material and the green quantum dot material are present in an amount of 4 wt % to 20 wt % respectively.

8. The liquid crystal display device according to claim 6, wherein the blue quantum dot material, the red quantum dot material, and the green quantum dot material are present in an amount of 4 wt % to 20 wt % respectively.

9. A method for manufacturing a liquid crystal display device, wherein:
the method comprises steps of:
Step S1, respectively manufacturing a color filter substrate and an array substrate and respectively performing surface treatment on the two substrates;
Step S2, respectively coating the color filter substrate and the array substrate with an alignment agent, and irradiating the alignment agent to form an alignment film; and
Step S3, assembling the color filter substrate and the array substrate, and
the liquid crystal display device comprises a plurality of pixel structures, wherein each pixel structure comprises a red sub-pixel, a green sub-pixel, and a blue sub-pixel, wherein an area of the blue sub-pixel is greater than or equal to a sum of an area of the red sub-pixel and an area of the green sub-pixel.

10. The method according to claim 9, wherein the pixel structures are in squares.

11. The method according to claim 9, wherein the area of the blue sub-pixel accounts for a half of an area of a pixel structure and the area of the red sub-pixel is equal to the area of the green sub-pixel.

12. The method according to claim 9, wherein the pixel structures are arranged in array.

13. The method according to claim 9, wherein:
a backlight of the liquid crystal display device is blue light;
the blue sub-pixel relies on the backlight to emit blue light; and
the red sub-pixel and the green sub-pixel are respectively doped with a red quantum dot material and a green quantum dot material which are blue-light excitable,
or wherein:
a backlight of the liquid crystal display device is white light; and
the blue sub-pixel, the red sub-pixel, and the green sub-pixel are respectively doped with a blue quantum dot material, a red quantum dot material, and a green quantum dot material.

14. The method according to claim 13, wherein the blue quantum dot material, the red quantum dot material, and the green quantum dot material are present in an amount of 4 wt % to 20 wt % respectively.

15. The method according to claim 11, wherein a photo-alignment method of the color filter substrate or the array substrate comprises steps of:
providing a glass substrate on a bearing platform;
irradiating the alignment agent on the glass substrate with linear polarized ultraviolet light by means of a mask, the linear polarized ultraviolet light passing through a light-transmitting region of the mask and irradiating a corresponding region of a pixel structure, so that the alignment agent on the pixel structure which is irradiated forms a first alignment direction; and
keeping the mask and irradiation direction of the linear polarized ultraviolet light unchanged, rotating the bearing platform, and respectively photo-aligning other regions of the pixel structure, so as to obtain an alignment film with different alignment directions.

16. The method according to claim 15, wherein the bearing platform is rotated for three times, each time rotated by 90°.

17. The method according to claim 16, wherein during the photo-alignment process, the glass substrate on a side of the array substrate is rotated by 90° relative to an initial position of the glass substrate on a side of the color filter substrate.

18. The method according to claim 15, wherein the mask used during the photo-alignment process has a same shape as the pixel structure, and the mask comprises a light-transmitting region and a light-shielding region, wherein the light-transmitting region has a same shape as the red sub-pixel or the green sub-pixel.

19. The method according to claim 15, wherein an irradiation angle Θ of the linear polarized ultraviolet light is 88°-89.7° during the photo-alignment process.
